(19) United States
(12) Patent Application Publication
(10) Pub. No.: US 2015/0040776 A1
(43) Pub. Date: Feb. 12, 2015

(54) Mister Baffler

(71) Applicant: Ernest Alan Emig, Elizabethtown, KY (US)

(72) Inventor: Ernest Alan Emig, Elizabethtown, KY (US)

(21) Appl. No.: 13/962,138

(22) Filed: Aug. 8, 2013

(51) Int. Cl. A47J 37/07

(52) U.S. Cl. CPC A47J 37/0786
USPC 99/444

(57) ABSTRACT

Mister Baffler was designed for assisting in the art of Bar-B-Queing meats, sometimes referred to as Smoking. Utilizing the many brands of Offset Smokers, such as Brinkmann, Char-Broil, New Brumsfeld, Char-Griller, Mister Baffler can be adapted to any Offset Smoker/cookers using a 90 Degree bend for different lengths for different Smoke chambers. There are no tools required to use the baffle, as it is placed over the end of any cooking grid and stays in place. By moving the cooking grid from left to right, the baffle either reduces or raises the temperature in the cooking/smoke chamber, resulting in a more evenly distributed cooking temperature in the cooking/smoke chamber.

Mister Baffler is made of a 12 inch by 11½ inch piece of 16 gauge steel, bent on a metal break at a 90 degree angle. (FIGS. 1 & 2)

The bottom two corners are cut off at a 45 degree angle so the Baffle will conform to the rounded bottom of a smoke chamber in an offset smoker/BBQ grill. (FIG. 3) It is then placed on the end of the smoke chamber cooking grid on the firebox end. (FIG. 4)

The heat and smoke is deflected by the baffle therefore reducing the cooking temperature at the firebox end of the smoker/cooker. (FIG. 5) The cooking grid can be slid back and forth, right or left, which will vary the amount of heat and smoke entering the smoke chamber by adjusting the amount of space between the Baffle/Firebox and the cooking chamber. (FIG. 6)

### BRIEF DESCRIPTION OF DRAWINGS/PHOTOGRAPHS

FIG. 1: 16 Gauge steel plate. 11½ inches by 12 inches.

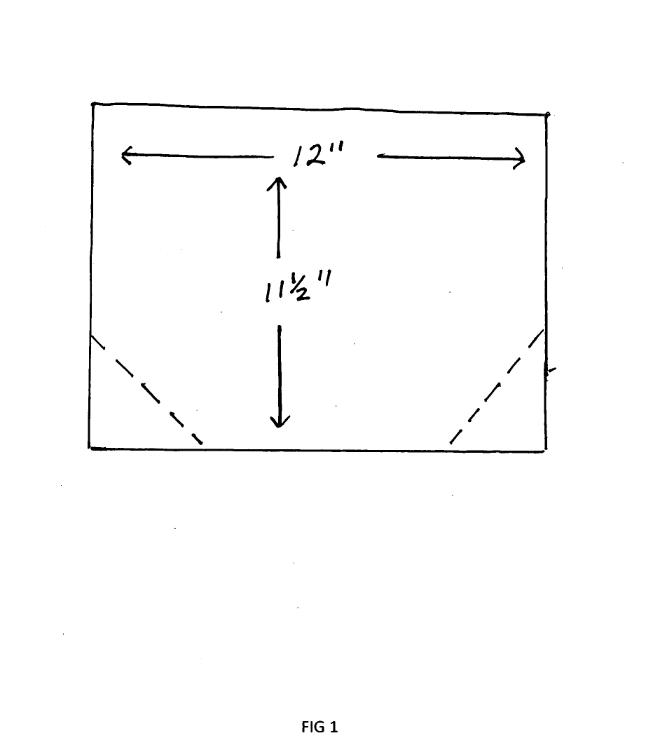

FIG. 2: Plate bent at a 90 degree angle.

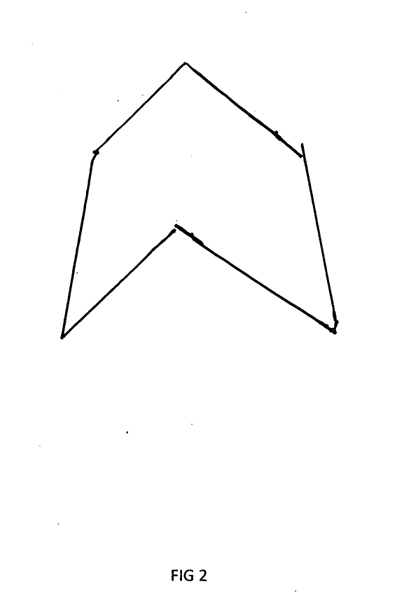

FIG. 3: Bottom corners cut off at a 45 degree angle.

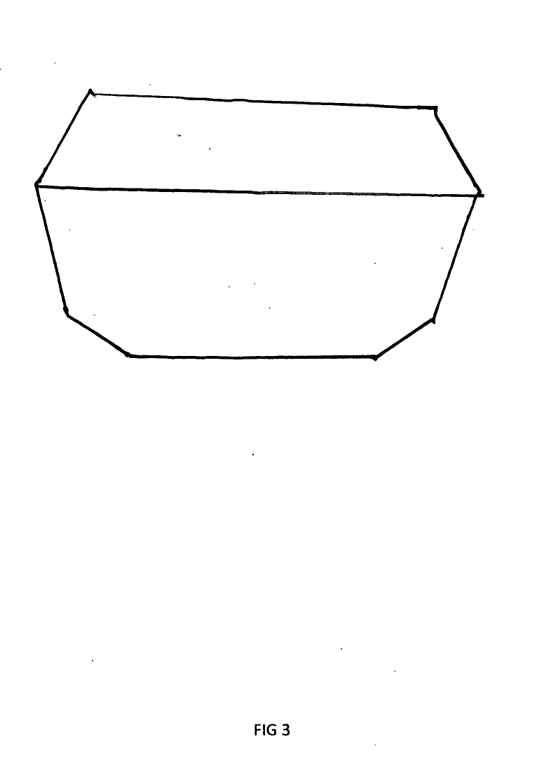

FIG. 4: Mister Baffler installed on an offset smoker.

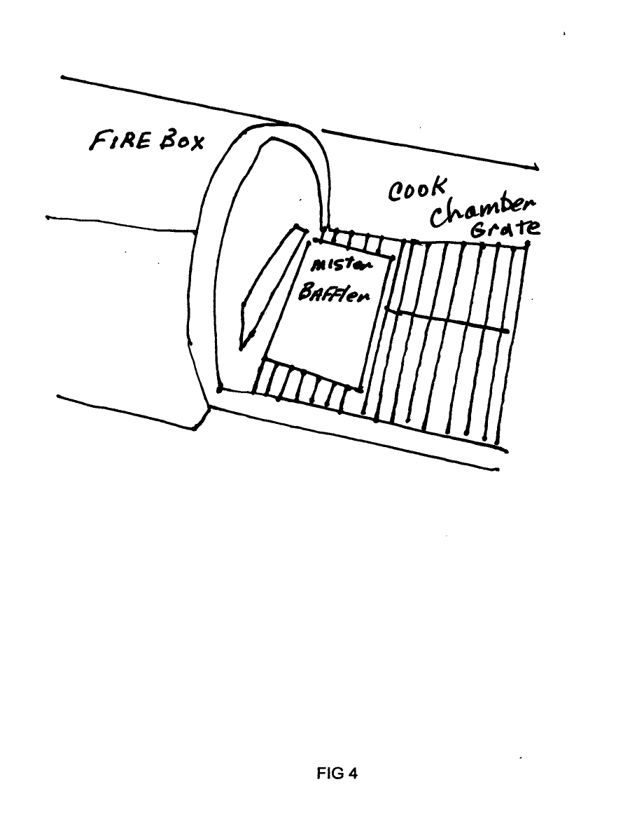

FIG. 5: Mister Baffler installed on an offset smoker fully closed

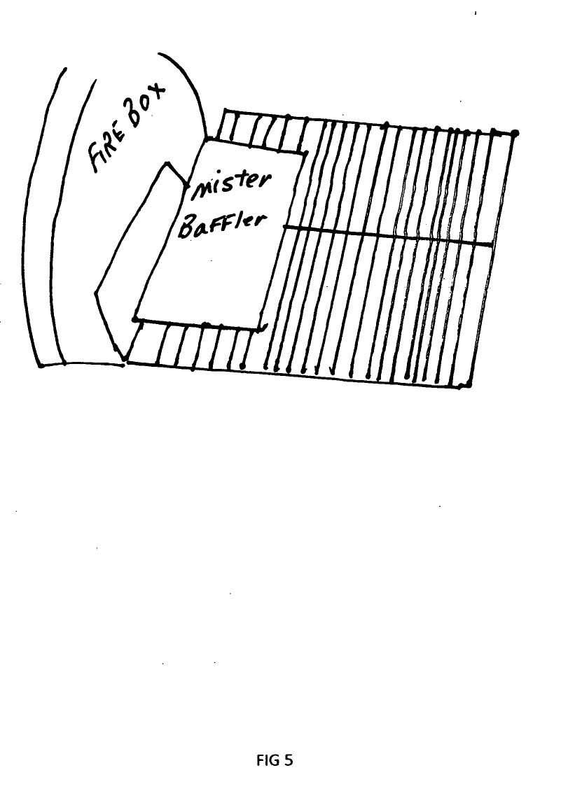

FIG. 6: Mister Baffler installed on an offset smoker fully open.

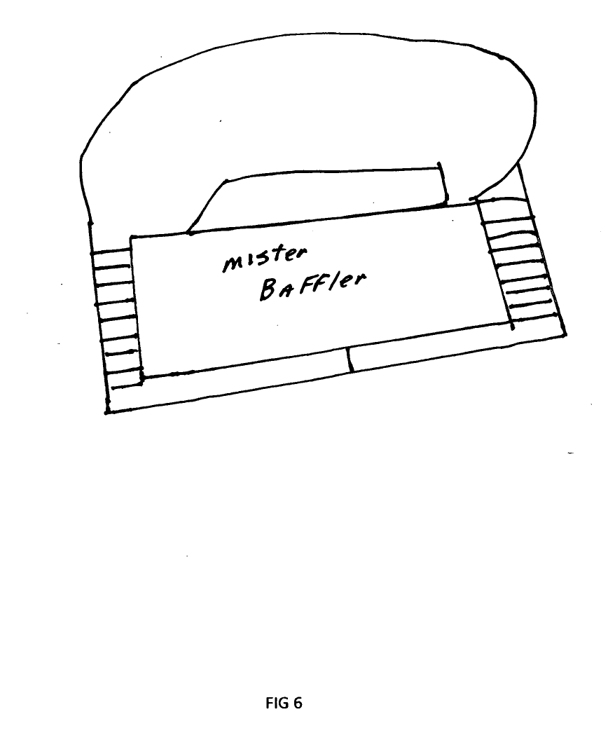

1. I, Ernest A. Emig, claim that by installing Mister Baffler on a variety of brands of offset smoker/grills, the cooking grid temperature can be maintained at a 10-20 degree difference between the left and right side of the cooking area. This allows the entire cooking chamber grid to be utilized for more meat to be cooked at the same time.
